(19) United States
(12) Patent Application Publication
(10) Pub. No.: US 2026/0163437 A1
(43) Pub. Date: Jun. 11, 2026

(54) METAL GASKET WITH EDGE BOND HYBRID SEAL

(71) Applicant: Schaeffler Technologies AG & Co. KG, Herzogenaurach (DE)

(72) Inventor: Matthew Payne, Glenmont, OH (US)

(73) Assignee: Schaeffler Technologies AG & Co. KG, Herzogenaurach (DE)

(21) Appl. No.: 18/975,139

(22) Filed: Dec. 10, 2024

(51) Int. Cl. H02K 5/10; H02K 5/22

(52) U.S. Cl. CPC H02K 5/10; H02K 5/225

(57) ABSTRACT

A metal gasket includes a metal plate formed as a continuous metal ring, a continuous metal bead formed into the continuous metal ring, and a continuous edge bond gasket fixed to the continuous metal ring. In an example embodiment, the continuous edge bond gasket is fixed to an inner edge of the continuous metal ring. In an example embodiment, the continuous edge bond gasket is an elastomeric seal. The disclosure also relates to a generator module including a housing, a high-voltage header, a junction box, and the metal gasket. The gasket is arranged to seal the high voltage header to the housing, and the junction box to the housing.

### TECHNICAL FIELD

The present disclosure relates generally to a metal gasket, and more specifically to a metal gasket with an edge bond hybrid seal.

### BACKGROUND

Busbars electrically conductively coupled to an electric machine and passing through an inverter housing are known from commonly-assigned United States Patent Application Publication No. 2023/0286364 titled ELECTRICALLY OPERABLE FINAL DRIVE TRAIN to Klein et al.

### SUMMARY

Example aspects broadly comprise a metal gasket including a metal plate formed as a continuous metal ring, a continuous metal bead formed into the continuous metal ring, and a continuous edge bond gasket fixed to the continuous metal ring. In an example embodiment, the continuous edge bond gasket is fixed to an inner edge of the continuous metal ring. In an example embodiment, the continuous edge bond gasket is an elastomeric seal. In some example embodiment, the metal plate has a rectangular outer shape with rounded corners. In an example embodiment, an inner edge of the metal plate has a rectangular shape with rounded corners. In an example embodiment, a distance from the continuous metal bead to an outer edge of the continuous metal ring is constant. In some example embodiment, the metal plate is flat except for the continuous metal bead. In an example embodiment, the metal plate is formed by stamping.

Other example aspects broadly comprise a generator module including a housing, a high-voltage header, a junction box, and the metal gasket. The gasket is arranged to seal the high voltage header to the housing, and the junction box to the housing. In some example embodiments, the continuous edge-bond gasket seals the high voltage header to the housing, and the continuous metal bead seals the junction box to the housing. In an example embodiment, the continuous metal bead is deformed between the junction box and the housing. In an example embodiment, the continuous metal bead is flattened between the junction box and the housing.

In an example embodiment, the housing includes a first planar surface, and the junction box includes a second planar surface arranged to compress the continuous metal bead against the first planar surface. In an example embodiment, the housing is formed from metal, and the high-voltage header is formed from plastic. In an example embodiment, the high-voltage header includes a ring-shaped protrusion arranged to compress the continuous edge-bond gasket against the housing.

### BRIEF DESCRIPTION OF THE DRAWINGS

FIG. 1 illustrates a perspective section view of a generator module.

FIG. 2 illustrates a detail view of the generator module of FIG. 1.

FIG. 3 illustrates a cross-sectional view of the generator module of FIG. 1.

FIG. 4 illustrates a cross-sectional view of a generator module having a metal gasket with an edge bond hybrid seal.

FIG. 5 illustrates a top view of the metal gasket of FIG. 4.

FIG. 6 illustrates a side view of the metal gasket of FIG. 5.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

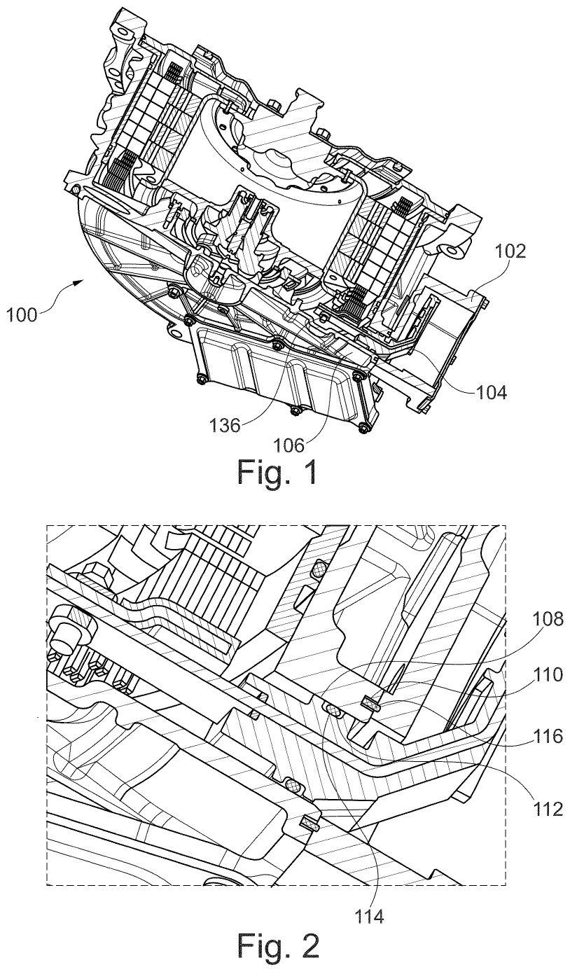

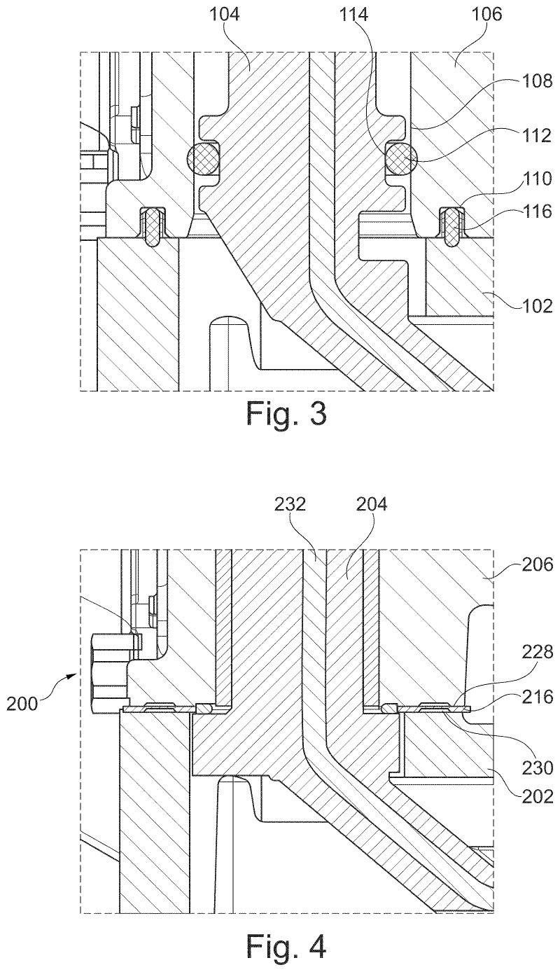

The following description is made with references to FIGS. 1-3. FIG. 1 illustrates a perspective section view of generator module 100. FIG. 2 illustrates a detail view of the generator module of FIG. 1. FIG. 3 illustrates a cross-sectional view of the generator module of FIG. 1. Module 100 uses a known sealing method for sealing junction box 102 and high voltage header 104 to housing 106. Housing 106 includes precision machined sealing surface 108 and groove 110. O-ring seal 112 is installed in groove 114 of high voltage header 104, and press-in-place seal 116 is installed in groove 110. Seal 112 is arranged to seal oil within module 100 to prevent leaks, and seal 116 is arranged to seal an inside of junction box 102 from external environmental contaminants (e.g., dust, water, etc.)

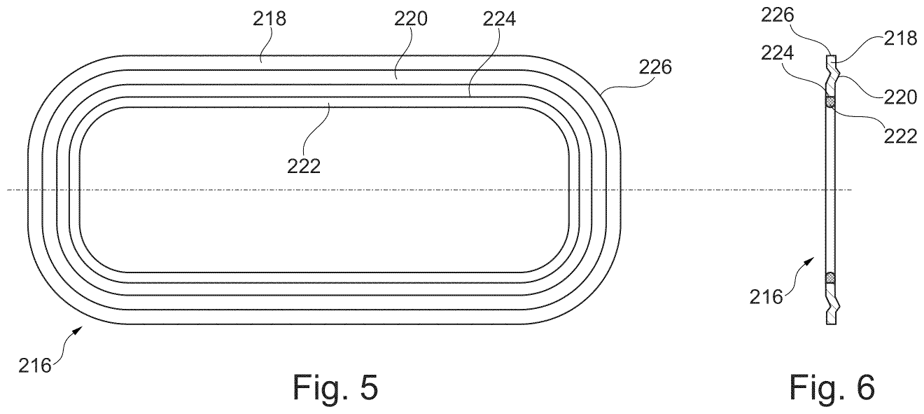

The following description is made with reference to FIGS. 5-6. FIG. 5 illustrates a top view of metal gasket 216. FIG. 6 illustrates a side view of the metal gasket of FIG. 5. Metal gasket 216 includes metal plate 218 formed as a continuous metal ring, continuous metal bead, or raised form, 220 formed into the continuous metal ring, and continuous edge bond gasket 222 fixed to the continuous metal ring. By continuous, I mean that the metal gasket, plate and edge gasket are formed as a loop with no breaks to assure a seal with mating components, as described below. By fixed, I mean that the edge gasket may be bonded to the metal plate by vulcanizing, for example. An additional sealing material (e.g., rubberized coating, not shown) may be applied to the metal bead to enhance sealing performance, for example. The continuous edge bond gasket is fixed to inner edge 224 of the continuous metal ring. In the embodiment shown, the continuous edge bond gasket is an elastomeric seal. Gasket material and hardness may be tuned to compensate for tolerances, for example.

Metal plate 218 has a rectangular outer shape with rounded corners. That is, outer edge 226 of the plate has two pairs of parallel lines formed orthogonal to one another, joined by radiused portions. Similarly, inner edge 224 of the metal plate has a rectangular shape with rounded corners. Although a particular shape is shown, other shapes are possible. For example, in other embodiments (not shown), metal plate 218 may be a round ring or have a polygonal shape. Inner edge 224 may be equidistant from outer edge 226 such that the metal plate has a constant width. In general, inner edge 224 is selected based on a shape of a high voltage header (discussed below), and the outer edge is offset from the inner edge. In the embodiment shown, a distance from continuous metal bead 220 to outer edge 226 of the continuous metal ring is constant. Similarly, a distance from the metal bead to inner edge 224 is also constant such that the metal bead is offset from the inner edge at an offset distance less than the outer edge. As shown, the offset distance is constant.

As best shown in FIG. 6, metal plate 218 is flat except for continuous metal bead 220. In the embodiment shown, metal plate 218 is formed by stamping. That is, the inner and outer edge of the metal plate is cut out of a flat, constant thickness sheet of material, and the metal bead is formed by pressing a ring-shaped die into the metal plate to deform the flat sheet and create the metal bead. In the embodiment shown, the metal bead is formed by a continuous V-shaped die such that a bottom surface of the metal bead has two flat surfaces joined at a point. Other embodiments (not shown) may include a rounded or semicircular die, for example, to form a rounded bottom surface of the metal bead.

The following description is made with reference to FIG. 4. FIG. 4 illustrates a cross-sectional view of generator module 200 having a metal gasket 216 with an edge bond hybrid seal 222. Generator module 200 includes housing 206, high-voltage header 204, junction box 202, and metal gasket 216 arranged to seal the high voltage header to the housing, and the junction box to the housing. Continuous edge-bond gasket 222 seals the high voltage header to the housing, and continuous metal bead 220 seals the junction box to the housing. The continuous metal bead is deformed between the junction box and the housing. As shown in FIG. 4, for example, the continuous metal bead is flattened between the junction box and the housing. Housing 206 includes planar surface 228 and junction box 202 includes planar surface 230 arranged to compress the continuous metal bead against planar surface 228. That is, as the junction box is tightened to the housing by fasteners (not shown), the metal bead is flattened between the two planar surfaces, compensating for any irregularities in the planar surfaces and preventing environmental debris from entering the junction box.

Housing 206 is formed from metal (e.g., aluminum) and high-voltage header 204 is formed from plastic, insulating high voltage current in busbars 232 from the metal housing. Header 204 includes ring-shaped protrusion, or molded plane, 234 arranged to compress continuous edge-bond gasket 222 against the housing. That is, when the high voltage header is pressed against the housing to insert connection bolts (not shown in FIG. 4, ref. similar bolts 136 in FIG. 1), the elastomeric seal is compressed to keep oil in the housing from leaking outside. Module 200 may include additional fasteners (not shown) securing the header directly to the housing, providing additional compression and enhanced sealing ability of the elastomeric seal.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Generator module
102 Junction box
104 High voltage header
106 Housing
108 Sealing surface (housing)
110 Groove (housing)
112 O-ring seal
114 Groove (high voltage header)
116 Press-in-place seal
136 Connection bolts (busbar)
200 Generator module
202 Junction box
204 High voltage header
206 Housing
216 Metal gasket
218 Metal plate
220 Metal bead
222 Edge bond gasket
224 Inner edge (metal plate)
226 Outer edge (metal plate)
228 Planar surface (first, housing)
230 Planar surface (second, junction box)
232 Busbars

What is claimed is:

1. A metal gasket, comprising:
a metal plate formed as a continuous metal ring;
a continuous metal bead formed into the continuous metal ring; and
a continuous edge bond gasket fixed to the continuous metal ring.

2. The metal gasket of claim 1, wherein the continuous edge bond gasket is fixed to an inner edge of the continuous metal ring.

3. The metal gasket of claim 1, wherein the continuous edge bond gasket is an elastomeric seal.

4. The metal gasket of claim 1, wherein the metal plate has a rectangular outer shape with rounded corners.

5. The metal gasket of claim 4, wherein an inner edge of the metal plate has a rectangular shape with rounded corners.

6. The metal gasket of claim 1, wherein a distance from the continuous metal bead to an outer edge of the continuous metal ring is constant.

7. The metal gasket of claim 1, wherein the metal plate is flat except for the continuous metal bead.

8. The metal gasket of claim 7, wherein the metal plate is formed by stamping.

9. A generator module, comprising:
a housing;
a high-voltage header;
a junction box; and
the metal gasket of claim 1 arranged to seal:
the high voltage header to the housing; and
the junction box to the housing.

10. The generator module of claim 9, wherein:
the continuous edge-bond gasket seals the high voltage header to the housing; and
the continuous metal bead seals the junction box to the housing.

11. The generator module of claim 10 wherein the continuous metal bead is deformed between the junction box and the housing.

12. The generator module of claim 10 wherein the continuous metal bead is flattened between the junction box and the housing.

13. The generator module of claim 9, wherein:
the housing comprises a first planar surface; and
the junction box comprises a second planar surface arranged to compress the continuous metal bead against the first planar surface.

14. The generator module of claim 9, wherein:
the housing is formed from metal; and
the high-voltage header is formed from plastic.

15. The generator module of claim 9, wherein the high-voltage header includes a ring-shaped protrusion arranged to compress the continuous edge-bond gasket against the housing.
